(19) United States
(12) Patent Application Publication
(10) Pub. No.: US 2024/0393787 A1
(43) Pub. Date: Nov. 28, 2024

(54) AUTONOMOUS TRANSPORTATION OF CARGO

(71) Applicants: Dominico P. Julian, Oakland, CA (US); Jeffrey M. Zerger, Pacifica, CA (US)

(72) Inventors: Dominico P. Julian, Oakland, CA (US); Jeffrey M. Zerger, Pacifica, CA (US)

(21) Appl. No.: 18/792,879

(22) Filed: Aug. 2, 2024

Related U.S. Application Data
(62) Division of application No. 17/833,872, filed on Jun. 6, 2022.
(60) Provisional application No. 63/208,442, filed on Jun. 8, 2021.

(51) Int. Cl. G05D 1/00; B63B 1/02; B63B 27/00; B63B 79/40; G08G 3/00; H04B 7/185

(52) U.S. Cl. CPC G05D 1/0206; B63B 1/02; B63B 27/00; B63B 79/40; G08G 3/00; H04B 7/18517; B63B 2213/02

(57) ABSTRACT

An autonomous vessel and method for transporting a cargo from an origin to a destination utilizing water currents, a satellite location system, and a satellite communication system includes a hull for navigating a body of water. A communication module is adapted for wireless communication with local contacts and the satellite communication system. A propulsion module is adapted to propel the hull through the body of water and preferably includes one or more relatively low-power electric motors. A navigation module is adapted to steer the hull towards a next waypoint. The navigation module preferably includes a rudder control system and is connected with a location module that is itself adapted for communication with the satellite location system to find a current location of the hull on the body of water. A controller is adapted for controlling the modules, sending information, and for receiving commands and information.

### CROSS REFERENCE TO RELATED APPLICATIONS

This application is a Divisional of U.S. Utility patent application Ser. No. 17/833,872, filed on Jun. 6, 2022, which claimed the benefit of U.S. Provisional Patent Application 63/208,442, filed on Jun. 8, 2021, now expired, both incorporated herein by reference.

### STATEMENT REGARDING FEDERALLY SPONSORED RESEARCH AND DEVELOPMENT

Not Applicable.

### FIELD OF THE INVENTION

This invention relates to autonomous ocean-faring vessels, and more particularly to a navigation method for minimizing energy requirements for such vessels.

### BACKGROUND

Humanity needs bold solutions to prevent sever climate change. One aspect of climate change solutions is the removal of CO₂, a greenhouse gas, from the atmosphere. One reservoir of CO₂ is earth's oceans, which regulates atmospheric CO₂ and continuously absorbs and releases atmospheric CO₂.

Seaweeds are some of the fastest growing organisms on the planet, but their natural range is limited to specific habitats typically near shore. Accordingly, increasing the area of seaweed growing in the oceans, and then sinking mature plants long term to the ocean floor, is one means of permanent atmospheric CO₂ reduction.

However, growing large farms of seaweed for subsequent sinking in the ocean is a costly endeavor that requires ships that themselves release CO₂ and other harmful exhaust components, and as such the efficiency of CO₂ removal is lowered.

Therefore, there is a need for an autonomous, unmanned system of transporting such seaweed farms from a cultivation location on the ocean or just offshore, to a deep dispersal area, in a manner that does not itself contribute significantly to atmospheric greenhouse gasses. Such a needed system would use existing ocean currents to the maximum extent possible for navigation and maintaining optimal seaweed growth conditions, and since travel time is not a great consideration, low-energy propulsion would be used to nudge such farms or other cargo into a next-optimal ocean current, preferably through the use of electric motors powered by solar energy or the like. Such a needed system would be useful for other time insensitive applications, and would be easily controlled from a central command center. Such a needed invention would use a minimum amount of energy and would use low cost, sustainable materials with corrosion resistant coatings or enclosures. The present invention accomplishes these objectives.

### SUMMARY OF THE INVENTION

The present device is an autonomous vessel and method for transporting a cargo from an origin to a destination utilizing water currents, a satellite location system, and a satellite communication system. The cargo may be growth platforms for seaweed, for example. But other cargo may be transported, such as garbage barges, low-speed cargo shipments, material excavation barges, or the like, where travel time and efficiency-of-route are not paramount considerations, but rather minimizing the use of overall trip power and personnel costs are the most important considerations.

The autonomous vessel comprises a hull adapted to navigate a body of water, such as an ocean. In preferred embodiments the hull is a surface hull adapted for floating on the body of water. In some embodiments the hull is sealed to prevent water from entering the hull, whereby buoyancy is ensured. Preferably the hull is designed to be run autonomously under navigation commands generated as described below.

In other embodiments the hull is a subsurface-capable hull, or submarine, adapted for either floating on the body of water or under a surface of the body of water. In such an embodiment, the hull may rise to the surface of the body of water when using a communication module and a location module, but can otherwise remain below the surface so as to ride-out a weather storm, or the like.

A communication module is adapted for wireless communication with local contacts and with the satellite communication system. Such wireless communication can utilize a bidirectional wireless communication protocol, or the like, for communicating with the local contacts, such as maintenance and support vessels or other platforms.

A propulsion module is adapted to propel the hull through the body of water. The propulsion module preferably includes one or more relatively low-power electric motors adapted for low-speed low-energy movement of the vessel and its cargo.

A navigation module is adapted to steer the hull towards a next waypoint. The navigation module preferably includes a rudder control system for controlling the position of one or more rudders, and is connected with a location module that is itself adapted for communication with the satellite location system to find a current location of the hull on the body of water. Alternately the vessel may be steered with two electric props in a skid-steering fashion.

A controller has at least a processor, a volatile memory, and a non-volatile memory. The controller is adapted for controlling the modules, storing weather models received from the communication module and navigating towards the next waypoint with the navigation module utilizing the propulsion module when unable to utilize the water currents. In some embodiments the controller is further adapted to determining a path from the current location to the destination utilizing the water currents, determining the next waypoint.

In some embodiments, the controller may be adapted to utilize the communication module to access updated weather models from a weather service accessible through the satellite communication system, or other local service. Preferably this is accomplished with the communication module accessing a network, such as the Internet, through which the weather service is available.

Further, suggested next waypoints and updated destination location information may also be accessed from a command center through the network, for example. In such an embodiment the controller is adapted to send the command center location information of the hull, module status information, cargo status information such as seaweed growth conditions and local current conditions, and local weather information.

A power source is included and adapted to power the controller and the modules. The power source preferably includes one or more solar energy collectors, such as photovoltaic solar collectors adapted to convert sunlight into electricity. Such a solar energy collectors preferably is used to keep a battery charged, the battery powering the controller, modules, electric motors, rudder control system, and the like. In some embodiments the one or more solar energy collectors may be separate from the hull and include a buoyant float for maintaining the solar energy collector above the water.

In use, the hull navigates to the destination through a series of the waypoints by utilizing the ocean currents when possible and the propulsion module when not. In embodiments without the command center, the following steps are typically performed by the vessel for autonomously transporting the cargo from the origin to the destination utilizing the water currents, the satellite location system, and the satellite communication system:
a) selecting the destination and designating the current position of the vessel as the origin.
b) analyzing a map of the current water currents in the body of water encompassing the origin and destination;
c) determining the paths between the origin and the destination that maximizes use of the water currents and minimizes use of the propulsion module;
d) attaching the cargo to the vessel if the cargo is not already attached to the vessel;
e) determining the next waypoint and a velocity to set for the propulsion module;
f) the navigation module adjusting course and speed based on the last known current location of the vessel;
f1) the navigation module adjusting course and speed based on the most recent weather forecast to avoid inclement weather;
f2) the navigation module adjusting course and speed to avoid known hazards including shipping lanes, shallow waters, and prohibited areas;
g) the controller activating the navigation module and propulsion module;
h) determining the current location, local conditions, module status information, and cargo status information;
h1) analyzing a current weather forecast received by the communication module;
h2) the controller utilizing the communication module to access a network having the updated weather models and water current and growth conditions, suggested next waypoints, and updated destination location information;
i) repeating from step f) until the next waypoint is reached; and
j) repeating from step e) until the vessel reaches the destination D.

In embodiments utilizing the command center, the additional step may be included in the method of autonomously transporting the cargo from the origin to the destination D:
h) the controller utilizing the communication module to access a command center connected with the network to send the command center location information of the hull, module status information, cargo status information, and local weather information, and to receive the next waypoint from the command center.

The present invention is an autonomous, unmanned system of transporting origin to a destination through a body of water, in a manner that does not itself contribute significantly to atmospheric greenhouse gasses. Navigation of the vessel utilizes existing ocean currents to the maximum extent possible, with low-energy propulsion used only to nudge the vessel and cargo into a next-optimal ocean current, preferably through the use of electric motors powered by solar energy or the like. The present system is useful for other time insensitive applications, and is easily controlled from a central command center. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of an autonomous vessel of the present invention;

FIG. 2 is a system diagram of the present invention;

FIG. 3 is a map diagram showing water currents and a path of the vessel from an origin to a destination; and

FIG. 4 is a diagram of a vessel of the present invention.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements, but can also mean a singular element.

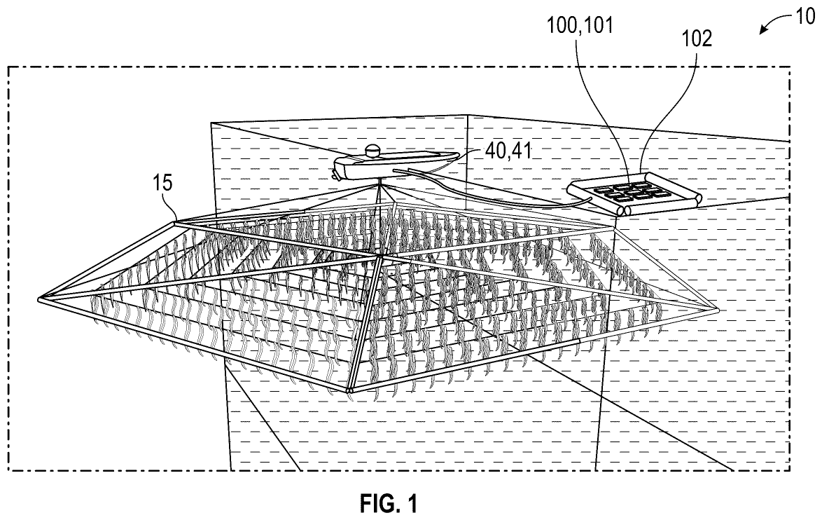

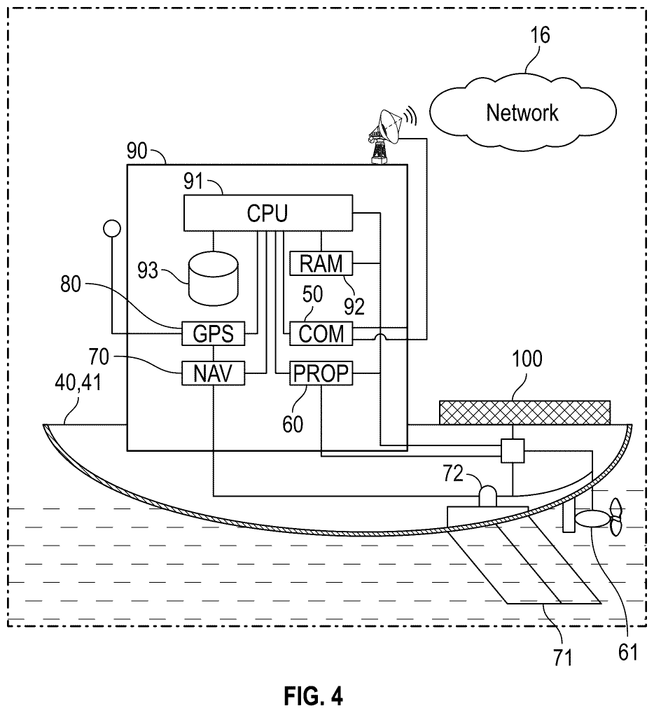

FIGS. 1-4 illustrate an autonomous vessel 10 for transporting a cargo 15 from an origin O1 to a destination D1 utilizing water currents 18, a satellite location system 20, and a satellite communication system 30. The cargo 15 may be large growth platforms for seaweed, as illustrated in FIG. 1, for example. But other cargo 15 may be transported, such as garbage barges, low-speed cargo shipments, material excavation barges, or the like.

The autonomous vessel 10 comprises a hull 40 adapted to navigate a body of water 17, such as an ocean. In preferred embodiments the hull 40 is a surface hull 41 adapted for floating on the body of water 17. In some embodiments the hull 40 is sealed to prevent water from entering the hull 40, whereby buoyancy is ensured. In other embodiments the hull 40 includes provisions for human operators (not shown), such as a bedroom, a bathroom, a food preparation area, and the like. However, preferably the hull 40 is designed to be run autonomously under navigation commands generated as described below.

In other embodiments the hull 40 is a subsurface-capable hull (not shown), or submarine, adapted for either floating on the body of water 17 or under a surface of the body of water 17. In such an embodiment, the hull 40 may rise to the surface of the body of water 17 when using the communication module 60 and location module 80, but can otherwise remain below the surface so as to ride-out a weather storm, or the like. In other embodiments the hull 40 takes the form of a buoy.

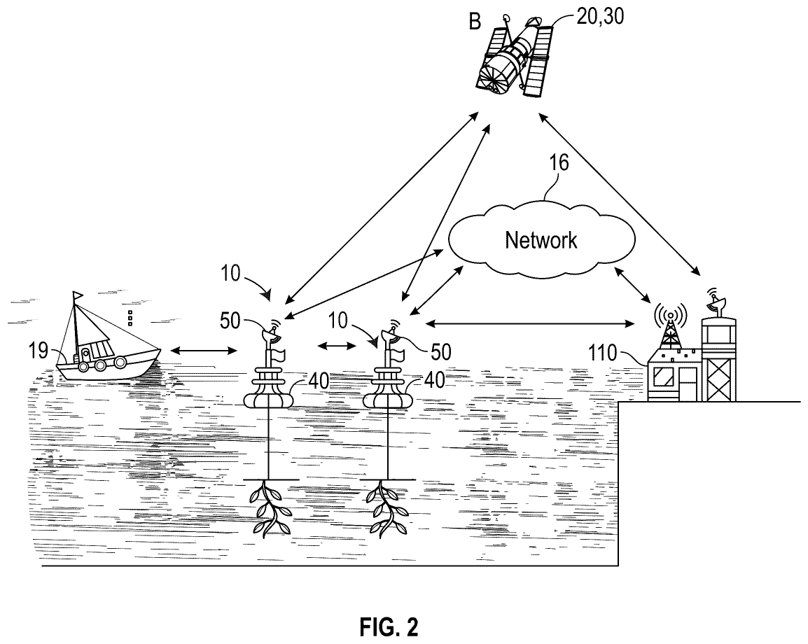

A communication module 50 is adapted for wireless communication with local contacts 19 (FIG. 2) and with the satellite communication system 30. Such wireless communication can utilize a bi-directional wireless communication protocol, or the like, for communicating with the local contacts 19, such as maintenance and support vessels 19 (FIG. 2). The communication module 50 may include a navigation broadcast system for broadcasting its position to nearby vessels, and may also include illuminated lamps to alert nearby vessels to the location of the hull 40 at night.

A propulsion module 60 is adapted to propel the hull 40 through the body of water 17. The propulsion module 60 preferably includes one or more relatively low-power electric motors 61 (with propellers) adapted for low-speed low-energy movement of the vessel 10 and its cargo 15.

A navigation module 70 is adapted to steer the hull 40 towards a next waypoint WX, such as W1, W2, etc. The navigation module 70 preferably includes a rudder control system 72 for controlling the position of one or more rudders 71, and is connected with a location module 80 that is itself adapted for communication with the satellite location system 20 to find a current location of the hull 40 on the body of water 17.

A controller 90 has at least a processor 91, a volatile memory 92, and a non-volatile memory 93. The controller is adapted for controlling the modules 50,60,70,80, storing weather models received from the communication module 50, determining a path PX from the current location to the destination D1 utilizing the water currents, determining the next waypoint WX, and navigating towards the next waypoint with the navigation module 70 utilizing the propulsion module 60 when unable to utilize the water currents 18.

In some embodiments, the controller 90 may be adapted to utilize the communication module 50 to access updated weather models from a weather service accessible through the satellite communication system 30, or other local service, as well as water current maps (herein collectively referred to as modelled environmental conditions). Preferably this is accomplished with the communication module 50 accessing a network 16, such as the Internet, through which the weather service is available.

Further, suggested next waypoints SWX and updated destination location information may also be accessed from a command center 110 through the network 16, for example. In such an embodiment the controller 90 is adapted to send the command center 110 location information of the hull 40, module status information, cargo status information, and local weather information. The local weather information can be obtained by an on-board weather station (not shown) that includes an anemometer, wind vane, pressure sensor, thermometer, hygrometer, and rain gauge, and further including sensors for detecting water temperature, turbidity and nutrient concentration, for example.

A power source 100 is included and adapted to power the controller 90 and the modules 50,60,70,80. The power source 100 preferably includes one or more solar energy collectors 101, such as photovoltaic solar collectors adapted to convert sunlight into electricity. Such a solar energy collectors 101 preferably is used to keep a battery 102 charged, the battery 102 powering the controller 90, modules 50,60,70,80, electric motors 61, rudder control system 72, and the like. In some embodiments the one or more solar energy collectors 101 may be separate from the hull 40 and include a buoyant float 102 for maintaining the solar energy collector above the water 17. Optionally, additional forms of power can be obtained by wind, wave, hydrogen, other climate-friendly sources, or reserve batteries if needed.

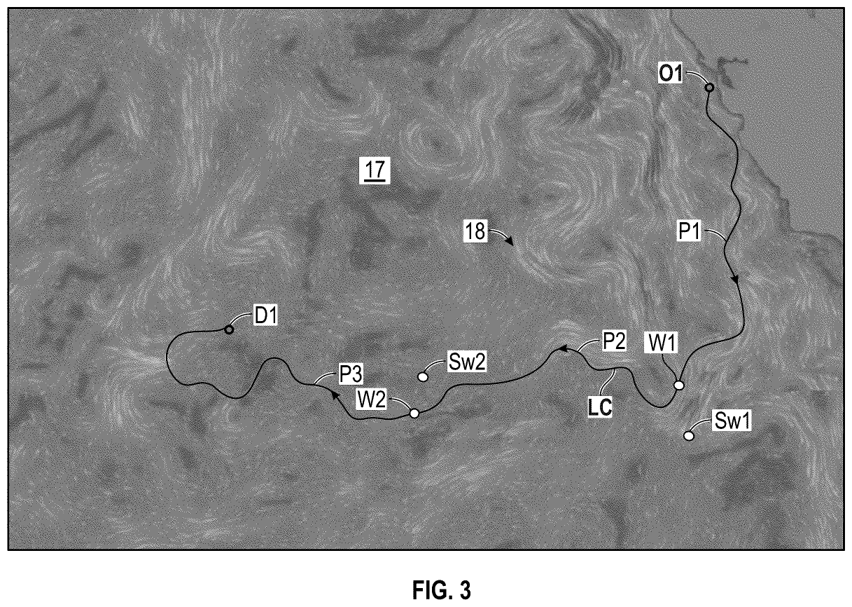

In use, the hull 40 navigates to the destination D1 through a series of the waypoints by utilizing the ocean currents 18 when possible and the propulsion module 60 when not. In embodiments without the command center 110, the following steps are typically performed by the vessel 10 for autonomously transporting the cargo 15 from the origin O1 to the destination D1 utilizing the water currents 18, the satellite location system 20, and the satellite communication system 30:
a) selecting the destination D1 and designating the current position of the vessel 40 as the origin O1.
b) analyzing a map of the current water currents 18 in the body of water 17 encompassing the origin O1 and destination D1 (FIG. 3);
c) determining the paths PX, such as P1, P2, P3, etc., between the origin O1 and the destination D1 that maximizes use of the water currents 17 and minimizes use of the propulsion module 60;
d) attaching the cargo 15 to the vessel 10 if the cargo 15 is not already attached to the vessel 10;
e) determining the next waypoint and a speed to set for the propulsion module 60;
f) the navigation module 70 adjusting course and speed based on the last known current location of the vessel 10;
f1) the navigation module 70 adjusting course and speed based on the most recent weather forecast to avoid inclement weather;
f2) the navigation module adjusting course and speed to avoid known hazards including shipping lanes, shallow waters, and prohibited areas;
g) the controller 90 activating the navigation module 70 and propulsion module 60;
h) determining the current location, module status information, and cargo status information;
h1) analyzing a current weather forecast received by the communication module;
h2) the controller utilizing the communication module to access a network having the updated weather models, suggested next waypoints, and updated destination location information;
i) repeating from step f) until the next waypoint is reached; and
j) repeating from step e) until the vessel 10 reaches the destination D1.

In embodiments utilizing the command center 110, the additional step may be included in the method of autonomously transporting the cargo 15 from the origin O1 to the destination D1:
h3) the controller utilizing the communication module to access a command center 110 connected with the network 16 to send the command center location information of the hull 40, module status information 120, cargo status information 130, and local weather information, and to receive the next waypoint from the command center 110.

In situations where the vessel 10 is to maintain a particular location, or within a preset distance of the particular location, the navigation module 70 can enter a desired station keeping mode where the propulsion module 60 counters the force of any of the ocean currents 17 that would otherwise carry the vessel away from the station keeping position. In some situations where neighboring ocean currents 17 are rotating or oppositely 6 directed, the navigation module 70 can navigate the vessel 10 to circle the desired station keeping position.

In the case wherein the cargo 15 is a seaweed farm, as illustrated in FIG. 1, the vessel 10 can be further outfitted with components to aid in growth and cultivation, including a winch for raising and lowering a seaweed platform, obtaining growth measurement data and ocean nutrient data, and the like.

While a particular form of the invention has been illustrated and described, it will be apparent that various modifications can be made without departing from the spirit and scope of the invention. Accordingly, it is not intended that the invention be limited, except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements 12 and acts of the various embodiments described above can be combined to provide further 13 embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with 6 which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. An autonomous vessel for transporting a cargo from an origin to a destination utilizing water currents, a satellite location system, and a satellite communication system, the autonomous vessel comprising:
a hull adapted to navigate a body of water;
a communication module adapted for wireless communication with local contacts and with the satellite communication system;
a propulsion module adapted to propel the hull through the water;
a navigation module adapted to steer the hull towards a next waypoint;
a location module adapted for communicating with the satellite location system to find a current location of the hull on the body of water;
a controller having at least a processor, a volatile memory, and a non-volatile memory, the controller adapted for controlling the modules, storing weather models received from the communication module, determining a path from the current location to the destination utilizing the water currents, determining the next waypoint, and navigating towards the next waypoint with the navigation module utilizing the propulsion module when unable to utilize the water currents; and
a power source adapted to power the controller and the modules;
whereby the hull navigates to the destination through a series of the waypoints by utilizing the ocean currents when possible and the propulsion module when not.

2. The autonomous vessel of claim 1 wherein the controller utilizes the communication module to access updated weather models from a weather service accessible through the satellite communication system.

3. The autonomous vessel of claim 2 wherein the controller utilizes the communication module to access a network having the updated weather models, suggested next waypoints, and updated destination location information.

4. The autonomous vessel of claim 3 wherein the controller utilizes the communication module to access a command center connected with the network, the controller adapted to send the command center location information of the hull, module status information, cargo status information, and weather information, and to receive the next waypoint from the command center and begin navigating towards the waypoint with the navigation module utilizing the propulsion module.

5. The autonomous vessel of claim 1 wherein the power source includes a solar energy collector.

6. The autonomous vessel of claim 5 wherein the solar energy collector includes a buoyant float for maintaining the solar energy collector above the water.

7. The autonomous vessel of claim 1 wherein the hull is a surface hull adapted for floating on the body of water.

8. The autonomous vessel of claim 1 wherein the hull is a subsurface-capable hull adapted for either floating on the body of water or navigating under a surface of the body of water.

9. An autonomous vessel for transporting a cargo from an origin to a destination utilizing water currents, a satellite location system, and a satellite communication system, the autonomous vessel comprising:
a hull adapted to navigate a body of water;
a communication module adapted for wireless communication with local contacts and with the satellite communication system;
a propulsion module adapted to propel the hull through the water;
a navigation module adapted to steer the hull towards a next waypoint;
a location module adapted for communicating with the satellite location system to find a current location of the hull on the body of water;
a controller having at least a processor, a volatile memory, and a non-volatile memory, the controller adapted for controlling the modules, storing weather models received from the communication module, determining a path from the current location to the destination utilizing the water currents, determining the next waypoint, and navigating towards the next waypoint with the navigation module utilizing the propulsion module when unable to utilize the water currents; and
a power source, including a solar energy collector, adapted to power the controller and the modules;
wherein the controller is adapted to utilize the communication module to access updated weather models from a weather service accessible through the satellite communication system, and to access a network having the updated weather models, suggested next waypoints, and updated destination location information, and to access a command center connected with the network, the controller adapted to send the command center location information of the hull, module status information, cargo status information, and weather information, and to receive the next waypoint from the command center and begin navigating towards the waypoint with the navigation module utilizing the propulsion module;
whereby the hull navigates to the destination through a series of the waypoints by utilizing the ocean currents when possible and the propulsion module when not.
